(19) United States
(12) Patent Application Publication
(10) Pub. No.: US 2006/0165101 A1
(43) Pub. Date: Jul. 27, 2006

(54) Communication arrangement for transmitting information messages between a plurality of decentralised communication units and at least one central communication unit

(76) Inventors: Tim Koppe, Ladebow (DE); Reinhard Rehberg, Sanz (DE)

Correspondence Address: Siemens Corporation;Intellectual Property Department, 170 Wood Avenue South, Iselin, NJ, 08830, US

(21) Appl. No.: 10/523,335

(22) PCT Filed: Jul. 24, 2003
(86) PCT No.: PCT/DE03/02499

§ 371 Date: Jan. 28, 2005

(30) Foreign Application Priority Data
Jul. 30, 2002 (DE) 102-34-724.7

(51) Int. Cl. H04L 12/56

(52) U.S. Cl. 370/401

(57) ABSTRACT

In order to transmit information messages towards a central communication unit, decentralised communication units are respectively connected to a central memory unit connected to at least one central communication unit, by means of a point-to-point connection. Control means associated with the memory unit are used to identify initial information messages of the information messages which are respectively transmitted via the respective point-to-point connections, and to respectively store the successive information messages in a memory region of the memory unit. Once the end information messages of the successive information messages have been identified, the respectively stored information messages are read out and transmitted onwards from the central memory unit to the central communication unit. Advantageously, the transmission resources located between the central communication unit and the decentralised communication units can be configured in an optimum manner and effectively used for the transmission of information messages towards the central communication unit.

### CROSS REFERENCE TO RELATED APPLICATIONS

This application is the US National Stage of International Application No. PCT/DE03/02499, filed Jul. 24, 2003 and claims the benefit thereof. The International Application claims the benefits of German application No. 10234724.7 DE filed Jul. 30, 2002, both of the applications are incorporated by reference herein in their entirety.

### FIELD OF INVENTION

This invention relates to a communication arrangement and method for transmitting information messages between a decentralized communication unit and a central communication unit

### BACKGROUND OF INVENTION

Network devices or communication devices usable in current communication networks frequently have one or more central modules and a plurality of remote or decentralized modules. A large number of transmission methods for the exchange of information messages between these modules within the communication device are known, which transmission methods are matched to variously fashioned physical transmission channels. Frequently, bus-oriented transmission methods are used such as, for example, the “broadcast method”, the “polling method” or the “collision method” (e.g. Ethernet).

In the case of the broadcast method, the information messages are sent from one module to a transmission medium used jointly by all the modules concerned, the sent information messages being received virtually simultaneously by all the modules connected to the transmission medium.

In the case of the polling method, by contrast, each remote or decentralized module or communication unit is polled in accordance with a predetermined sequence, for example with the aid of a telegram requesting information messages to be transmitted. A synchronization mechanism ensures that a defined time frame or time slot is made available to the respective module for sending the information messages to be transmitted to the jointly used transmission medium. A disadvantage of this transmission method is that modules are also polled which have neither information messages to transmit nor information messages to receive. As a result, the transmission resources provided by the jointly used transmission medium are not used optimally.

In the case of the collision method, the information messages to be transmitted are sent by the modules connected to the jointly used transmission medium on a random basis, whereby it can occur that information messages are sent to the transmission medium simultaneously by a plurality of modules and that conflicts in accessing the transmission medium are caused as a result. In the case of collisions of this kind, a repeat sending is carried out with the aid of a mechanism developed specifically for the purpose. A disadvantage of the collision method is that it cannot be ensured with absolute certainty that a message to be transmitted will also be received in the envisaged time interval at the envisaged destination.

Furthermore, circuit arrangements are known in which a central module or communication unit is connected respectively via separate point-to-point connections to the respective decentralized modules. A disadvantage of this variant of the arrangement is that a very high transmission rate has to be provided for the interface arranged between the central module or communication unit and the decentralized modules or communication units, since, irrespective of whether there actually exists information or messages to be transmitted between the modules, the transmission capacity of the circuit arrangement has to be designed for the worst-case scenario, i.e. for the case where all the decentralized modules connected to the central module simultaneously wish to transmit information towards the central module.

### SUMMARY OF INVENTION

The object of the present invention is to create a facility for the exchange of information between central and decentralized modules, in which facility, in particular, optimum use is made of the transmission resources provided for the exchange of information. The object is achieved in the features characterized, based on a communication arrangement and method according to the claims.

In the communication arrangement according to the invention, in order to transmit information between a plurality of decentralized communication units and at least one central communication unit, the information messages sent respectively from the decentralized communication unit to the at least one central communication unit have respectively a start information message indicating the start of the respectively transmitted information messages and an end information message indicating the end of the respectively transmitted information messages. The essential advantage of the communication arrangement according to the invention is that the decentralized communication units are respectively connected via a point-to-point connection to a central memory device connected to the at least one central communication unit. Control means are assigned to the central memory device, which control means are fashioned such that the start information messages of the information messages transmitted respectively from at least one of the decentralized communication units via the respective point-to-point connection are identified. Once the start information message has been identified, the information messages subsequently arriving via the respective point-to-point connection are respectively stored in a memory area provided in the memory device. The end information message of the information message respectively arriving via the point-to-point connection is identified, whereby, once the end information message has been identified, the respectively stored information messages are read out from the memory area and the information messages read out are transmitted onwards to the at least one central communication unit.

The essential advantage of the communication arrangement according to the invention is that in order to transmit information messages outgoing from the decentralized communication units or modules toward the at least one central communication unit no jointly used transmission medium is used, but a combination consisting of a logical bus structure and a point-to-point structure. The logical bus structure in this case can also be fashioned as a point-to-point connection. A central memory unit or a central data memory with associated control means or memory manager is connected between the decentralized communication units and the at least one central communication unit. The information messages of all decentralized communication units to be transmitted respectively can be transmitted to this data memory or memory manager virtually simultaneously or in parallel at a respectively random transmission rate via the respectively configured point-to-point connections. The control means are advantageously fashioned such that the information messages arriving via the respectively configured point-to-point connections can also be received and further processed or stored simultaneously or in parallel. The information messages stored are then transmitted from this central data memory with the aid of a random transmission method—for example a point-to-point connection with a defined transmission capacity—to the central communication unit. The transmission method implemented between the central communication unit and the central memory device is advantageously independent of the interface implemented between the central memory device and the decentralized communication units. This has the advantage that the transmission resources required in order to transmit information messages from the decentralized communication units toward the central communication unit are flexibly scalable or configurable. Since a separate connection, i.e. a connection independent of others, is configured respectively between the decentralized [communication units] and the central memory device, the usual dimensioning of the interface arranged between the central memory device and the decentralized communication units for the “worst-case scenario” can be waived and transmission resources consequently saved.

Further advantages arising out of the embodiments of the communication arrangement and method according to the invention will be seen from the dependent claims.

### BRIEF DESCRIPTION OF THE DRAWING

FIG. 1—exemplary block diagram of the communication arrangement.

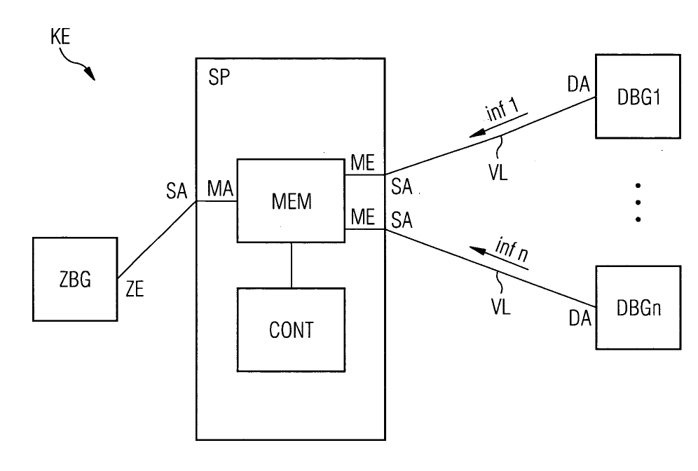

### DETAILED DESCRIPTION OF INVENTION

The communication arrangement according to the invention will be described in detail below with reference to a block diagram. The block diagram shows a plurality of decentralized communication units DBG1 . . . n, fashioned as remote modules, which are connected respectively via an outlet DA and an interoffice trunk VL, representing a point-to-point connection, to a terminal SA of a central memory device SP. Memory means MEM fashioned as a central data memory are provided in the memory device SP, to which memory means are assigned control means CONT—memory manager. The memory means MEM are respectively connected via one inlet ME and one terminal SA of the memory device SP to a decentralized module DBG1 . . . n.

The memory means MEM are connected via an outlet MA and via a terminal SA of the memory device SP to an inlet ZE of a central communication unit ZBG fashioned as a central module. The connection between the central communication unit ZBG and the central memory device SP can be implemented by means of a random transmission medium providing definable transmission resources or with the aid of a random transmission method.

The elements or modules ZBG, DBG1 . . . n, SP shown in the block diagram are in this embodiment an integral part of a network element KE arrangeable in a communication network, for example an integral part of a DSLAM (Digital Subscriber Line Access Multiplexer) multiplexer unit.

It is assumed for the further embodiments that communication unit-specific information messages inf1 . . . n have respectively to be transmitted from the respective decentralized communication units DBG1 . . . n toward the central communication unit ZBG. To this end, the information messages inf1 . . . n to be respectively transmitted from a decentralized communication unit DBG1 . . . n respectively have a start information message representing the start of the information messages to be transmitted and an end information message representing the end of the information messages to be transmitted. The combination of information messages to be transmitted in connection with the start and end information messages is referred to below as a data telegram. The data telegrams can be fashioned e.g. as HDLC frames. It should be noted that the data telegrams can also be fashioned in the form of data packets or data cells or data frames adapted in conformity with current transmission methods (e.g. Ethernet, TCP/IP, ATM). For the arrangement according to the invention it is crucial only that the individual data telegrams or data packets or data frames have a significant information message for identifying the start and the end of the respectively transmitted information messages.

The data telegrams inf1 . . . n to be transmitted from the decentralized communication units DBG1 . . . n are transmitted via the respective interoffice trunks VL at random times—that is, possibly also simultaneously—to the central memory device SP. Since according to the invention no jointly used transmission medium is provided for the interface between the central memory device SP and the decentralized communication units DBG1 . . . n, each decentralized communication unit can transmit at a random transmission rate whenever a data telegram inf1 . . . n that is to be sent, i.e. is complete, is ready for sending in the respective decentralized communication unit DBG1 . . . n. By this means, the data telegrams to be sent can also be transmitted simultaneously at respectively different transmission rates to the central memory unit SP.

The control means CONT assigned to the memory means MEM are fashioned according to the invention such that both the start information messages and the end information messages of the information messages to be transmitted respectively via the interoffice trunks VL are identified. Once a start information message has been identified, the information messages of the data telegram inf1 . . . n arriving subsequently at the memory device SP are stored by the control means CONT without further interference in a memory area of the memory means MEM provided respectively for the purpose, the control means being fashioned such that data telegrams inf1 . . . n transmitted virtually simultaneously from the decentralized communication units DBG1 . . . n are also stored in the area of the memory means MEM respectively provided until the respective end information messages are identified. In this embodiment, the data telegrams inf1 . . . n transmitted respectively to the memory device SP are stored, read out and transmitted onward to the central communication unit ZBG, together with the identified start and end information messages. It should be noted that according to an alternative design variant, the information messages transmitted inf1 . . . n can also be stored in the central memory device SP and transmitted onward without start and end information messages.

Once an end information message has been identified by the control means CONT, the associated and now complete data telegram is read out from the memory area and forwarded from the central memory unit SP via the outlet SA to the central communication unit ZBG. The control means CONT assigned to the memory means MEM are fashioned such that permanently complete data telegrams stored in the memory means MEM are identified, read out and forwarded to the central communication unit ZBG. The transmission of information messages between central module ZBG and central memory device SP is independent of the interface configured between the central memory device and the decentralized communication units DBG1 . . . n. For example, the connection arranged between the central communication unit ZBG and the central memory unit SP can also be fashioned as a point-to-point connection with defined transmission capacity, this connection fulfilling the logical function of a data bus via which all information messages inf1 . . . n or data telegrams sent from the decentralized communication units DBG1 . . . n are transmitted.

1.-9. (canceled)

10. A communication arrangement for a transmitting information messages between a decentralized communication unit and a central communication unit, comprising:
a point-to-point connection between the decentralized communication unit and a central memory device, the central memory device operatively connected to the central communication unit;
a controller assigned to the central memory device;
a memory area provided in the central memory device;
a start information message of the information messages transmitted from the decentralized communication unit via the point-to-point connection identified by the controller;
a subsequent information message transmitted via the point-to-point connection stored in the memory area by the controller; and
an end information message of the information messages arriving via the point-to-point connection identified by the controller, the stored information message read out from the memory area and transmitted to the central communication unit.

11. The communication arrangement according to claim 10, wherein the start and end information messages are stored in the memory device.

12. The communication arrangement according to claim 10, wherein the start and end information messages are transmitted to the central communication unit.

13. The communication arrangement according to claim 10, wherein a second point-to-point connection is configured between the central communication unit and the central memory device, the controller adapted so the information message read out of memory is transmitted as part of a transmission method via the second point-to-point connection.

14. The communication arrangement according to claim 10, wherein the the information messages transmitted via the point-to-point connection are transmitted within a framework of a data packet or a data telegram or a data frame having the start and end information message.

15. The communication arrangement according to claim 14, wherein the data frame is an HDLC frame.

16. The communication arrangement according to claim 10, further comprising a plurality of decentralized communication units.

17. The communication arrangement according to claim 16, wherein the information messages transmitted from the one central communication unit toward the plurality of decentralized communication units are transmitted via a broadcast transmission method.

18. The communication arrangement according to claim 10, wherein the point-to-point connection is implemented via an interoffice trunk.

19. The communication arrangement according to claim 10, wherein central communication unit and the decentralized communication units are an integral part of a communication device arrangeable in a communication network.

20. The communication arrangement according to claim 19, wherein the central communication unit and the decentralized communication units are fashioned respectively as modules arranged in the communication device.

21. A method for transmitting and receiving information messages between a decentralized communication unit and a central communication unit, comprising:
a point-to-point connection between the decentralized communication unit and a central memory device, the central memory device operatively connected to the central communication unit;
identifying a start information message of the information messages, the information messages received from the decentralized communication unit via a point-to-point connection;
receiving a subsequent information message transmitted via the point-to-point connection, the subsequent message stored in a memory area;
identifying an end information message of the information messages arriving via the point-to-point connection;
reading the stored information message from the memory area; and
transmitting the read message to the central communication unit.

22. The method according to claim 21, wherein the step of identifying a start information message further includes storing the start message in the memory area.

23. The method according to claim 22, wherein the step of identifying an end information message further includes storing the end message in the memory area.

24. The method according to claim 23, wherein the start and end information messages are transmitted to the central communication unit.

25. The method according to claim 21, wherein a second point-to-point connection is configured between the central communication unit and the central memory device.
